(19) United States
(12) Patent Application Publication
(10) Pub. No.: US 2023/0399208 A1
(43) Pub. Date: Dec. 14, 2023

(54) CRANE DEFORMATION STATE ESTIMATION SYSTEM

(71) Applicant: KOBELCO CONSTRUCTION MACHINERY CO., LTD., Hiroshima-shi (JP)

(72) Inventors: Nobuhiro TAKAMATSU, Tokyo (JP); Satoshi OKADA, Tokyo (JP); Tomotaka MITANI, Tokyo (JP)

(73) Assignee: KOBELCO CONSTRUCTION MACHINERY CO., LTD., Hiroshima-shi (JP)

(21) Appl. No.: 18/250,414

(22) PCT Filed: Oct. 15, 2021
(86) PCT No.: PCT/JP2021/038272

§ 371 Date: Apr. 25, 2023

(30) Foreign Application Priority Data
Nov. 2, 2020 (JP) 2020-183536

(51) Int. Cl. B66C 23/90

(52) U.S. Cl. CPC B66C 23/905; B66C 2700/08

(57) ABSTRACT

A technology capable of reducing a data amount required for a estimation processing while maintaining accuracy for estimation of a virtual deformation state of an attachment which receives external force in a crane is provided. A deformation state of each of a boom (first attachment element) and a jib (second attachment element) configuring an attachment connected to a crane main body so as to perform a derricking motion is estimated according to a crane model. The crane model is a model indicating a correlation among an “acting force factor” for specifying an acting state of force on the attachment connected to the crane main body so as to perform the derricking motion, a “posture factor” for specifying respective postures of the boom and the jib, and “angle changes (elevation angle deviations Δθ₁ and Δθ₂)” indicating respective deformation states of the boom and the jib.

### TECHNICAL FIELD

The present invention relates to a technology of estimating a virtual deformation state of an attachment which is deformed according to each of external force and inertial force in a crane.

### BACKGROUND ART

A technology of detecting deformation of a structure member such as a jib of a crane has been proposed (for example, see Patent Literature 1). In order to improve productivity and safety for a crane field, BIM (Building Information Modeling) has been adopted. In an execution stage, selection of a heavy machine needed for execution and a planning of lifting a construction machine such as a crane are needed, and in such selection and planning, deflection in a heavy machine model may be three-dimensionally expressed by using the BIM.

### CITATION LIST

### Patent Literature

Patent Literature 1: Japanese Patent Laid-Open No. 2020-158225

### SUMMARY OF INVENTION

### Technical Problem

However, when expressing a deformation state of the attachment by displacing each of a plurality of points of a structure member such as a jib configuring a crane in a virtual space coordinate system for each combination of a posture of the structure member and a factor which causes deformation of the structure member, such as weight of an object lifted by the crane, a data amount becomes excessive.

Therefore, an object of the present invention is to provide a technology capable of reducing a data amount required for the estimation processing while maintaining accuracy for estimation of a virtual deformation state of an attachment which receives external force in a crane.

### Solution to Problem

A crane deformation state estimation system of the present invention is
the system comprising an arithmetic processing unit for estimating a virtual deformation state of an attachment which is connected to a crane main body so as to perform a derricking motion in a crane and is deformed according to each of external force and inertial force, and
the arithmetic processing unit comprises:
an input processing element configured to recognize an acting force factor for specifying an acting state of force on the attachment and a posture factor for specifying a posture of the attachment, which are inputted through an input interface;
an estimation processing element configured to estimate, as a deformation state of the attachment, an angle change state indicating the deformation state of the attachment in a condition where the force is acting on the attachment in the state specified by the acting force factor with the posture specified by the posture factor for the attachment as a reference, according to a crane model indicating a correlation among the acting force factor, the posture factor and the angle change state indicating the deformation state of the attachment, based on the acting force factor and the posture factor recognized by the input processing element; and
an output processing element configured to make an output interface output information indicating the deformation state of the attachment estimated by the estimation processing element.

According to the crane deformation state estimation system of the configuration, the deformation state of the attachment connected to the crane main body so as to perform the derricking motion is estimated according to the crane model. The crane model is a model indicating the correlation among the “acting force factor” for specifying the acting state of the force on the attachment connected to the crane main body so as to perform the derricking motion, the “posture factor” for specifying the posture of the attachment and the “angle change state” indicating the deformation state of the attachment. That is, in the crane model, the deformation state of the attachment according to the acting state of the force on the attachment in a certain posture is expressed by the angle change state of the attachment. Therefore, accuracy for estimation of the deformation state of the attachment can be improved even while reducing a data amount by expressing the deformation state specified by a deflection amount of the attachment or the like by a single angle representing a plurality of points, compared to a case of expressing it by respective displacement states of a plurality of parts of the attachment or respective displacement vectors of the plurality of points.

In the crane deformation state estimation system of the present invention,
it is preferable that
the input processing element recognizes, as the posture factor, each of a first posture factor for specifying the posture of a first attachment element which configures the attachment and is connected to the crane main body so as to perform the derricking motion and a second posture factor for specifying the posture of a second attachment element directly or indirectly connected to the first attachment element so as to change at least one of the posture and a position, and
the estimation processing element estimates, as the deformation state of the attachment, the angle change state indicating the posture change state of each of the first attachment element and the second attachment element in the condition where the force is acting on the attachment in the state specified by the acting force factor with the posture specified by the posture factor for the attachment as the reference.

According to the crane deformation state estimation system of the configuration, the deformation state of each of the first attachment element and the second attachment element configuring the attachment connected to the crane main body so as to perform the derricking motion is estimated according to the crane model. The crane model is the model indicating the correlation among the “acting force factor” for specifying the acting state of the force on the attachment connected to the crane main body so as to perform the derricking motion, the “posture factor” for specifying the respective postures of the first attachment element and the second attachment element and the “angle change state” indicating the deformation state of each of the first attachment element and the second attachment element. That is, in the crane model, the deformation state of each of the first attachment element and the second attachment element configuring the attachment according to the acting state of the force on the attachment in a certain posture is expressed by the angle change state of each of the first attachment element and the second attachment element. Therefore, the accuracy for estimation of the deformation state of each attachment element can be improved even while reducing the data amount, compared to the case of expressing the deformation state specified by the deflection amount or the like of each attachment element by the respective displacement states of the plurality of parts of each attachment element or the respective displacement vectors of the plurality of points.

In the crane deformation state estimation system of the present invention,
it is preferable that the input processing element recognizes weight of a suspended load lifted by the attachment as the acting force factor.

According to the crane deformation state estimation system of the configuration, by specifying the weight of the suspended load by a user through the input interface, an angle of the attachment according to the force acting on the attachment when the suspended load having the specified weight is lifted is estimated as the deformation state.

### BRIEF DESCRIPTION OF DRAWINGS

FIG. 1 is a configuration explanatory drawing of a crane deformation state estimation system.

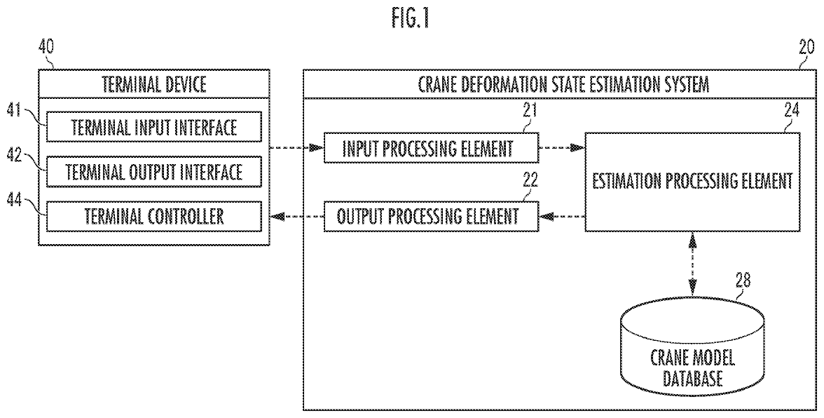

FIG. 2 is a schematic explanatory drawing of a crane expressed by a detailed crane model.

FIG. 3 is a configuration explanatory drawing of the crane.

FIG. 4 is an explanatory drawing regarding a simple crane model.

FIG. 5 is a flowchart illustrating a crane deformation state estimation method.

FIG. 6 is an explanatory drawing regarding an output state of an estimation result of a crane deformation state.

### DESCRIPTION OF EMBODIMENTS

(Configuration of Crane Deformation State Estimation System)

A crane deformation state estimation system 20 is configured by a server connected with a terminal device 40 in an intercommunicable manner via a network.

The crane deformation state estimation system 20 comprises an input processing element 21, an output processing element 22, an estimation processing element 24, and a crane model database 28. The crane model database 28 may be configured by a database server different from the server configuring the crane deformation state estimation system 20.

Each of the input processing element 21, the output processing element 22 and the estimation processing element 24 is configured by one or more arithmetic processing units (such as CPUs, single-processor cores and multi-processor cores). The arithmetic processing unit has a function of reading data and a program (computer software) stored in a storage device (such as a memory and a hard disk) and executing arithmetic processing according to the program based on the data.

The terminal device 40 is configured by a portable information processor such as a smartphone, a tablet terminal and a laptop computer. The terminal device 40 comprises a terminal input interface 41, a terminal output interface 42, and a terminal controller 44. The terminal input interface 41 is configured by manual operation type keys and/or buttons and a voice recognition device as needed. An expression “A and/or B” means “at least one of A and B”. Similarly, the expression “A, B and/or C” means “at least one of A, B and C”. The terminal output interface 42 is configured by an image display device and a voice output device as needed. The terminal input interface 41 and the terminal output interface 42 may be configured by a touch panel. The terminal controller 44 is configured by an arithmetic processing unit (such as a CPU, a single-processor core and a multi-processor core). The arithmetic processing unit has the function of reading data and a program (computer software) stored in a storage device (such as a memory and a hard disk) and executing arithmetic processing according to the program based on the data.

(Configuration of Crane Expressed by Detailed Crane Model)

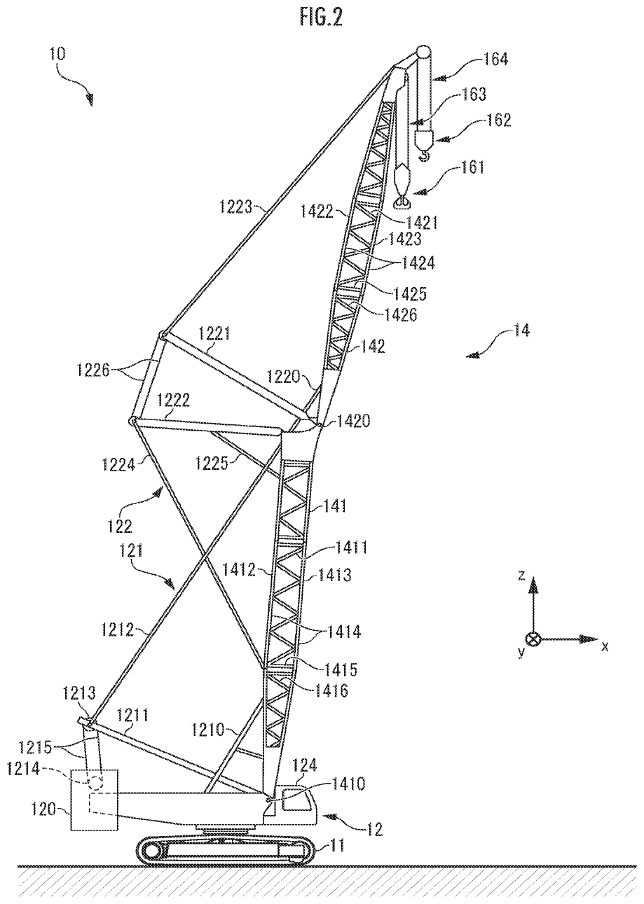

FIG. 2 illustrates an example of the crane expressed by the detailed crane model. According to the detailed crane model, coordinate values of a plurality of points pₙ(0) (n=1, 2, . . . N) of a crane 10 in the case where the crane is in a no-load condition and is not deformed are defined, and the coordinate values of a plurality of points pₙ(m) of the crane 10 in the case where the crane is in a loaded condition and is deformed are computed or calculated according to FEM (finite element method). A movable crane 10 illustrated in FIG. 2 comprises a lower traveling body 11, an upper turning body 12, a boom derricking device 121, a jib derricking device 122, a boom 141 and a jib 142. By the lower traveling body 11 and the upper turning body 12, a “crane main body” is configured. By the boom 141 (first attachment element) and the jib 142 (second attachment element), an “attachment 14” is configured.

Kinds and specifications of the crane 10 and kinds of the attachment 14 may be variously changed. By the kinds and specifications of the crane 10 and the kinds of the attachment 14, the “type” of the crane 10 is defined. The crane 10 may not be a crawler crane and may be a different movable crane such as a wheel crane (a tire traveling crane, a rough-terrain crane, a track crane, an all-terrain crane) or may be a fixed crane such as a jib crane, a climbing crane or a tower crane. The crane 10 may be a luffing crane or a fixed jib crane other than the tower crane. The jib 142 may be omitted and the crane 10 may comprise the boom 141 as the attachment 14. The boom 141 may be a latticed boom other than a Telesco (R) (telescopic) boom.

An actual machine coordinate system in virtual space defining the detailed crane model, for which a position and a posture are fixed relative to the crane 10, is defined by a z axis parallel to a turning axis of the upper turning body 12 relative to the lower traveling body 11, an x axis parallel to a front-rear direction of the upper turning body 12 and a y axis orthogonal to each of the z axis and the x axis. The actual machine coordinate system is appropriately referred to in order to explain the position and/or the posture of components of the crane 10.

The lower traveling body 11 has the function of moving relative to a ground surface with which a crawler and/or a wheel is in contact by transmitting power of a motor to the crawler and/or the wheel, for example. The upper turning body 12 is on an upper side of the lower traveling body 11 and is turnably connected to the lower traveling body 11. The upper turning body 12 comprises a counterweight 120 for taking balance in the front-rear direction of the crane 10, and a cab 124 (driver's cab).

The boom 141 is attached so as to perform a derricking motion to both left and right sides of the upper turning body 12 via a pair of left and right boom foot pins 1410 (foot pins) respectively. The boom 141 may be a latticed boom having a lattice structure for which pipes are combined, or may be a telescopic boom having a box-shaped structure.

When the boom 141 is a latticed boom, a cross-sectional shape of the boom 141 vertical to a longitudinal direction of the boom 141 is roughly quadrangular. The boom 141 comprises left and right side faces 1411, a back surface 1412 and a ventral surface 1413. Each of the left and right side faces 1411 of the boom 141 faces each of a left direction (+y direction) and a right direction (−y direction). The back surface 1412 of the boom 141 faces a rear direction (−x direction) of the boom 141 in a state where the boom 141 is raised. The ventral surface 1413 of the boom 141 faces a front direction (+x direction) of the boom 141 in the state.

When the boom 141 is a telescopic boom in a box-shaped structure, the cross-sectional shape of the boom 141 to the longitudinal direction of the boom 141 is roughly quadrangular. In this case, a contour line corresponding to the ventral surface 1413 on the cross section may be a roughly semicircular shape or a roughly circular arc shape. When the boom 141 is a latticed boom, the pipes that configure the boom 141 are main columns 1414, stringers 1415, beams (not illustrated), and braces 1416. The main columns 1414 are the pipes which are arranged at four corner parts of a quadrangle cross section of the boom 141 and extend in the longitudinal direction of the boom 141. The stringers 1415 configure the side faces 1411 and extend in the direction orthogonal to the longitudinal direction of the boom 141 and a horizontal direction Y respectively. The non-illustrated beams are the pipes which configure the back surface 1412 and the ventral surface 1413 and extend in a left-right direction. The braces 1416 configure a surface of the boom 141 and extend in the direction inclined to each of the main columns 1414, the stringers 1415 and the beams.

To each of left and right of the back surface 1412 of the boom 141, each of a pair of left and right boom backstops 1210 is attached. The boom backstops 1210 (backstops) limit a rotation of the boom 141 and consequently limit the rotation in the rear direction of the boom 141 relative to the upper turning body 12. An upper end part of the boom backstops 1210 may be able to be in contact with the boom 141, or may be connected to the boom 141. A lower end part of the boom backstops 1210 may be able to be in contact with the upper turning body 12, or may be connected to the upper turning body 12. At least one end part of the upper end part and the lower end part of the boom backstops 1210 is connected to a structure (the boom 141 or the upper turning body 12) adjacent to the end part. The boom backstops 1210 may be extendable and contractable by a spring, may be extendable and contractable by a hydraulic pressure, or may be extendable and contractable by the spring and the hydraulic pressure. It is same for jib backstops 1220.

The boom derricking device 121 for making the boom 141 perform the derricking motion relative to the crane main body or the upper turning body 12 to the upper turning body 12 comprises a mast 1211, boom guylines 1212 (guylines), an upper spreader 1213, a lower spreader 1214 and a boom derricking rope 1215.

The mast 1211 is attached to the upper turning body 12 so as to perform the derricking motion, and is arranged more in the rear direction than the boom 141. The mast 1211 comprises left and right (two) main columns and a member which connects the left and right main columns with each other.

The boom guylines 1212 (guylines) are connected to a distal end part (an opposite side of a side attached to the upper turning body 12) of the mast 1211 and a distal end part of the boom 141. The boom guylines 1212 are members comprising at least either of a link member (guy link) and a rope (guy rope) (same for jib guylines 1223 and strut guylines 1224 to be described later). The (two) boom guylines 1212 are provided on left and right, and are attached to left and right parts of the boom 141 and the mast 1211 respectively.

The upper spreader 1213 is a device comprising a plurality of sheaves and is arranged at the distal end part of the mast 1211. The lower spreader 1214 is a device comprising a plurality of sheaves and is arranged at a rear direction end part of the upper turning body 12. The boom derricking rope 1215 is put around the lower spreader 1214 and the upper spreader 1213. Therefore, when the boom derricking rope 1215 is wound or paid out by a winch (not illustrated), an interval of the lower spreader 1214 and the upper spreader 1213 changes. As a result, the mast 1211 performs the derricking motion relative to the upper turning body 12. Since the mast 1211 and the boom 141 are connected by the boom guylines 1212, when the mast 1211 performs the derricking motion relative to the upper turning body 12, the boom 141 performs the derricking motion relative to the upper turning body 12.

The jib 142 is connected so as to perform the derricking motion or be rotatable to both left and right sides of the boom 141 via a pair of left and right jib foot pins 1420 (foot pins) respectively. The jib 142 can perform the derricking motion relative to the crane main body or the upper turning body 12 via the boom 141. The jib 142 may be a latticed jib having a lattice structure, or may have a box-shaped structure.

Similarly to the boom 141, the jib 142 comprises left and right side faces 1421, a back surface 1422 and a ventral surface 1423. Similarly to the boom 141, the pipes configuring the jib 142 include main columns 1424, stringers 1425, beams (not illustrated), and braces 1426.

To both left and right sides of the back surface 1422 of the jib 142, a pair of left and right jib backstops 1220 are attached respectively. The jib backstops 1220 (backstops) limit the rotation of the jib 142 and consequently limit the rotation in the rear direction of the jib 142 relative to the boom 141. One end in the longitudinal direction of the jib backstops 1220 may be connected to the jib 142 or may be able to be in contact with the jib 142. The other end (the end on the opposite side of the side connected to the jib 142) in the longitudinal direction of the jib backstops 1220 may be able to be in contact with the distal end part of the boom 141 or may be connected to the distal end part of the boom 141. At least one end part of one end and the other end of the jib backstops 1220 is connected to the structure (the jib 142 or the boom 141) adjacent to the end part.

The jib derricking device 122 for rotating the jib 142 relative to the boom 141 comprises a front strut 1221, a rear strut 1222, jib guylines 1223 (guylines), strut guylines 1224 (guylines) and a jib derricking rope 1226. The struts 1221 and 1222 can perform the derricking motion relative to the distal end part of the boom 141, and are arranged more in the rear direction than the jib 142. The front strut 1221 may be attached to the distal end part of the boom 141 so as to perform the derricking motion, or may be attached to a base end part of the jib 142 so as to perform the derricking motion. The front strut 1221 may have a lattice structure or may have a box-shaped structure. It is the same for the rear strut 1222. On the distal end part of the front strut 1221, a plurality of sheaves are provided. It is the same for the rear strut 1222. The rear strut 1222 is attached to the distal end part of the boom 141 so as to perform the derricking motion. The rear strut 1222 is arranged more in at least either one of the lower direction and the rear direction than the front strut 1221.

Only one strut may be provided or three or more struts may be provided. While a backstop (rear strut backstop 1225) is attached to the rear strut 1222, the backstop may be attached to the front strut 1221.

The jib guylines 1223 (guylines) are connected to the distal end part of the front strut 1221 and the distal end part of the jib 142. The pair of left and right jib guylines 1223 are attached to each of the left side and the right side of each of the jib 142 and the front strut 1221.

The strut guylines 1224 (guylines) are connected to the distal end part of the rear strut 1222 and the boom 141. The pair of left and right strut guylines 1224 are attached to each of the left side and the right side of each of the rear strut 1222 and the boom 141.

The jib derricking rope 1226 is put around the sheaves at the respective distal end parts of the front strut 1221 and the rear strut 1222. Therefore, when the jib derricking rope 1226 is wound or paid out by the non-illustrated winch, an interval of the distal end part of the rear strut 1222 and the distal end part of the front strut 1221 changes. As a result, the front strut 1221 performs the derricking motion relative to the boom 141. Since the front strut 1221 and the jib 142 are connected by the jib guyline 1223, when the front strut 1221 performs the derricking motion relative to the boom 141, the jib 142 performs the derricking motion relative to the boom 141.

Operations of the crane 10 are controlled by an actual machine operation mechanism configured by an operation lever and a pedal or the like arranged inside the cab 124 being operated by an operator riding inside the cab 124. The operations of the crane 10 may be remotely controlled by a remote operation mechanism configured by an operation lever and a pedal or the like configuring a remote operation device being operated by an operator. The crane 10 is driven by a drive mechanism configured by a hydraulic circuit comprising a hydraulic pump, a hydraulic actuator and a control valve or the like, for example.

The crane 10 further comprises a main hoisting hook 161, an auxiliary hoisting hook 162, a main hoisting wire rope 163 for hoisting the main hoisting hook 161, and an auxiliary hoisting wire rope 164 for hoisting the auxiliary hoisting hook 162. By each of the main hoisting wire rope 163 and the auxiliary hoisting wire rope 164 being hoisted or lowered by different winches (not illustrated), each of the main hoisting hook 161 and the auxiliary hoisting hook 162 is elevated and lowered.

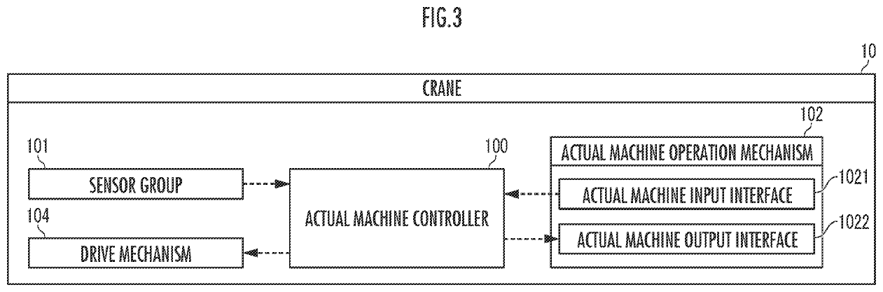

As illustrated in FIG. 3, the crane 10 comprises an actual machine controller 100, a sensor group 101, an actual machine operation mechanism 102 and a drive mechanism 104. The configurations are the configurations omitted when expressing the crane in the detailed crane model.

The actual machine operation mechanism 102 is loaded in the cab 124 (driver's cab) configuring a part of the upper turning body 12. The actual machine operation mechanism 102 comprises an actual machine input interface 1021 and an actual machine output interface 1022. The actual machine input interface 1021 is configured by an operation lever and an operation button or the like for the operations of the crane 10, such as a moving operation of the lower traveling body 11 and a turning operation of the upper turning body 12 relative to the lower traveling body 11. The actual machine output interface 1022 is configured by an acoustic output device in addition to an image display device. The operation lever, the operation button and the image display device and the like are arranged around a seat where the operator sits inside the cab 124.

The sensor group 101 is configured by a sensor for measuring a position of an upper end part of the boom 141 or a displacement amount of each of four columns 1414 configuring the upper end part, and a sensor for measuring the position of an upper end part (distal end part) of the jib 142 or a displacement amount of each of four columns 1424 configuring the upper end part. The sensor group 101 is further configured by a sensor for measuring an elevation angle (or a derricking angle) and an azimuth of the boom 141 around the boom foot pins 1410, a sensor for measuring a turning angle (or a derricking angle) and an azimuth of the jib 142 around the jib foot pins 1420, a sensor for measuring tension generated to a wire for the suspended load and a paid-out length of the wire, and a sensor for measuring a turning angle of the upper turning body 12 relative to the lower traveling body 11 and the like. When the boom 141 is a latticed boom, the sensor for measuring an extension length of the boom 141 is omitted.

The drive mechanism 104 is configured by an actuator and a power transmission mechanism and the like for achieving movement of the lower traveling body 11, turning of the upper turning body 12 relative to the lower traveling body 11, the derricking motion and/or telescopic motion of each of the boom 141 and the jib 142, and winding or payout of the wire and the like, according to an operation mode of an actual machine operation lever or the like configuring the actual machine input interface 1021.

(Crane Model)

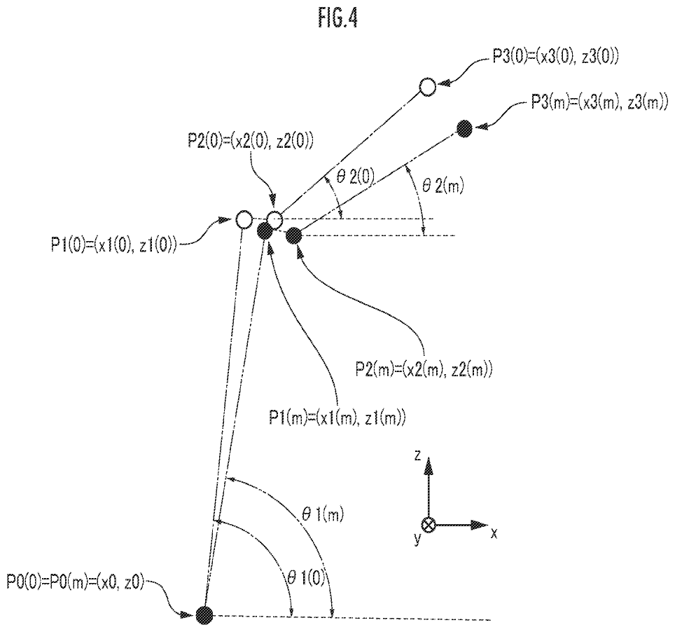

According to a simple crane model for expressing a deformation state of the attachment 14 of the crane 10 of the configuration described above, as illustrated in FIG. 4, the attachment 14 is expressed by a skeleton on a plane parallel to an x-z plane of the actual machine coordinate system.

In FIG. 4, each of points P₀(0), P₁(0), P₂(0) and P₃(0) corresponds to each of the boom foot pins 1410, the distal end part (for example, an attaching position of the rear strut 1222) of the boom 141, the jib foot pins 1420 and the distal end part of the jib 142 in a condition where the suspended load is not lifted by the attachment 14 (the no-load condition where gravity of the suspended load is not acting on the attachment 14).

In the no-load condition, for example, an average value of the coordinate values of two points p₁₄₁₀₁(0) and p₁₄₁₀₂(0) indicating the left and right boom foot pins 1410 respectively is defined as a coordinate value (x₀(0), y₀(0), z₀(0)) of the point P₀(0). Similarly, an average value of the coordinate values of two points p₁₄₂₀₁(0) and p₁₄₂₀₂(0) indicating the left and right jib foot pins 1420 respectively is defined as a coordinate value (x₂(0), y₂(0), z₂(0)) of the point P₂(0). In addition, an average value of the coordinate values of four points p₁₄₁₄₁(0), p₁₄₁₄₂(0), p₁₄₁₄₃(0) and p₁₄₁₄₄(0) indicating the four columns 1414 configuring the distal end part of the boom 141 or the distal end parts thereof respectively is defined as a coordinate value (x₁(0), y₁(0), z₁(0)) of the point P₁(0). Similarly, an average value of the coordinate values of four points p₁₄₂₄₁(0), p₁₄₂₄₂(0), p₁₄₂₄₃(0) and p₁₄₂₄₄(0) indicating the four columns 1424 configuring the distal end part of the jib 142 or the distal end parts thereof respectively is defined as a coordinate value (x₃(0), y₃(0), z₃(0)) of the point P₃(0).

Respective elevation angles θ₁(0) and θ₂(0) relative to a horizontal plane of the boom 141 (which corresponds to a line segment P₀(0)-P₁(0)) and the jib 142 (which corresponds to a line segment P₂(0)-P₃(0)) are expressed by following relational expressions (01) and (02).

θ₁(0)=tan⁻¹{(z₁(0)−z₀(0)/(x₁(0)−x₀(0))} (01)

θ₂(0)=tan⁻¹{(z₃(0)−z₂(0))/(x₃(0)−x₂(0))} (02)

In FIG. 4, each of points P₀(m), P₁(m), P₂(m) and P₃(m) corresponds to each of the boom foot pins 1410, the distal end part of the boom 141, the jib foot pins 1420 and the distal end part of the jib 142 in the condition where the suspended load of mass m is lifted by the attachment 14 (the loaded condition where the gravity of the suspended load is acting on the attachment 14).

In the loaded condition, for example, an average value of the coordinate values of two points p₁₄₁₀₁(m) and p₁₄₁₀₂(m) indicating the left and right boom foot pins 1410 respectively, calculated according to the FEM (finite element method), is calculated as a coordinate value (x₀(m), y₀(m), z₀(m)) of the point P₀(m). Similarly, an average value of the coordinate values of two points p₁₄₂₀₁(m) and p₁₄₂₀₂(m) indicating the left and right jib foot pins 1420 respectively, calculated according to the FEM (finite element method), is calculated as a coordinate value (x₂(m), y₂(m), z₂(m)) of the point P₂(m). In addition, an average value of the coordinate values of four points p₁₄₁₄₁(m), p₁₄₁₄₂(m), p₁₄₁₄₃(m) and p₁₄₁₄₄(m) indicating the four columns 1414 configuring the distal end part of the boom 141 or the distal end parts thereof respectively, calculated according to the FEM (finite element method), is calculated as a coordinate value (x₁(m), y₁(m), z₁(m)) of the point P₁(m). Similarly, an average value of the coordinate values of four points p₁₄₂₄₁(m), p₁₄₂₄₂(m), p₁₄₂₄₃(m) and p₁₄₂₄₄(m) indicating the four columns 1424 configuring the distal end part of the jib 142 or the distal end parts thereof respectively, calculated according to the FEM (finite element method), is calculated as a coordinate value (x₃(m), y₃(m), z₃(m)) of the point P₃(m). Depending on the specifications of the crane 10, as the coordinate value indicating the point of the distal end part of the boom 141 or the jib 142, the coordinate value of the point indicating the sheaves that suspend the hooks 161 and 162 or an average value of the coordinate values of the plurality of points may be used.

Respective elevation angles θ₁(m) and θ₂(m) relative to the horizontal plane of the boom 141 (which corresponds to a line segment P₀(m)-P₁(m)) and the jib 142 (which corresponds to a line segment P₂(m)-P₃(m)) are expressed by following relational expressions (21) and (22).

θ₁(m)=tan⁻¹{(z₁(m)−z₀(m)/(x₁(m)−x₀(m))} (21)

θ₂(m)=tan₋₁{(z₃(m)−z₂(m))/(x₃(m)−x₂(m))} (22)

A deviation Δθ₁=θ₁(m)−θ₁(0) of the elevation angle relative to the horizontal plane of the boom 141 indicates the deformation state or a deflection amount of the boom 141 when the suspended load of the mass m is lifted by the attachment 14 in the condition where the boom 141 is in the posture of forming the elevation angle θ₁(m)(˜the derricking angle to the upper turning body 12) relative to the horizontal plane and the jib 142 is in the posture of forming the elevation angle θ₂(m) (˜the derricking angle to the upper turning body 12) relative to the horizontal plane. A deviation Δθ₂=θ₂(m)−θ₂(0) of the elevation angle relative to the horizontal plane of the jib 142 indicates the deformation state or the deflection amount of the jib 142 when the suspended load of the mass m is lifted by the attachment 14 in the condition where the boom 141 is in the posture of the elevation angle θ₁(m) relative to the horizontal plane and the jib 142 is in the posture of the elevation angle θ₂(m) relative to the horizontal plane.

The posture (specified by the elevation angle θ₁(m) of the boom 141 and the elevation angle θ₂(m) of the jib 142) of the attachment 14 and the mass m of the suspended load lifted by the attachment 14 are variously changed and then the elevation angle deviations Δθ₁ and Δθ₂ indicating the deformation state of the attachment 14 as described above are repeatedly specified. As a result, the simple crane model indicating a correlation among the posture of the attachment 14, the mass m of the suspended load (an acting state of force on the attachment 14) and the deformation state of the attachment 14 expressed by the elevation angle deviation (an angle change state) is defined by a table, a function or a model parameter or the like. The simple crane model is constructed separately for each type of the crane 10 similarly to the detailed crane model and registered in the crane model database 28 in association with a type identifier for identifying the type.

(Functions)

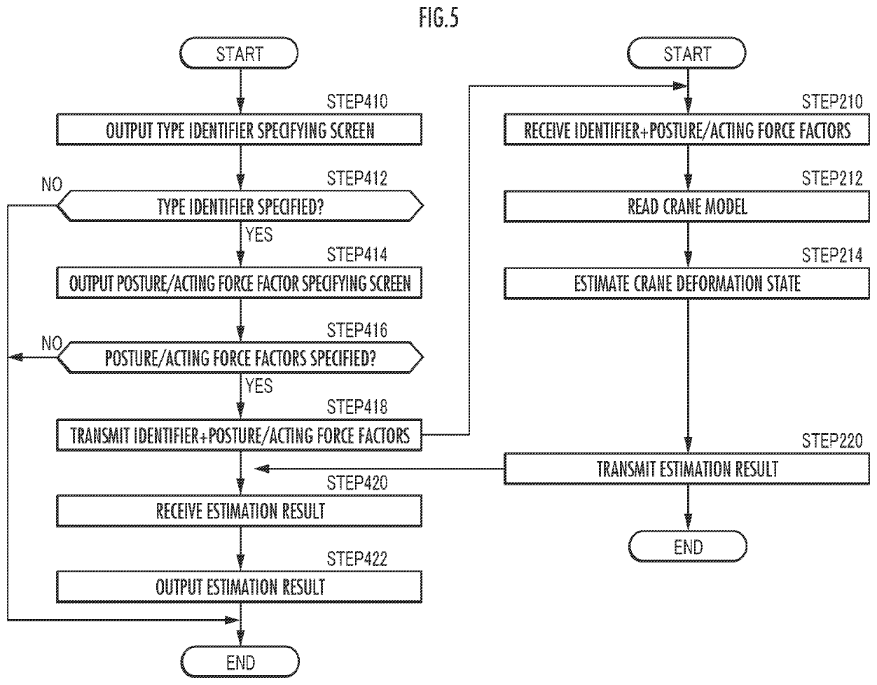

The functions of the crane deformation state estimation system 20 of the configuration described above will be explained using a flowchart in FIG. 5.

As a specified operation such as activation of a specified application (application software) is performed through the terminal input interface 41 in the terminal device 40, a screen for specifying the type identifier is outputted to the terminal output interface 42 by the terminal controller 44 (FIG. 5/STEP 410).

By the terminal controller 44, whether or not the type identifier is specified within a fixed period of time through the terminal input interface 41 is determined (FIG. 5/STEP 412). When the determination result is negative (FIG. 5/STEP 412 . . . NO), processing after STEP 410 is repeated.

When the determination result is affirmative (FIG. 5/STEP 412 . . . YES), a screen for specifying a posture factor and an acting force factor is outputted to the terminal output interface 42 by the terminal controller 44 (FIG. 5/STEP 414).

The “acting force factor” is a factor for specifying the acting state of the force on the attachment 14. For example, the mass of the suspended load lifted by the attachment 14 corresponds to the acting force factor. The “posture factor” is a factor for specifying the posture of the attachment 14. For example, the elevation angle θ₁(m) (˜the derricking angle to the upper turning body 12) relative to the horizontal plane of the boom 141 and the elevation angle θ₂(m) (—the derricking angle to the upper turning body 12) relative to the horizontal plane of the jib 142 correspond to the posture factor.

By the terminal controller 44, whether or not the posture factor and the acting force factor are specified within the fixed period of time through the terminal input interface 41 is determined (FIG. 5/STEP 416). When the determination result is negative (FIG. 5/STEP 416 . . . NO), the processing after STEP 410 is repeated.

When the determination result is affirmative (FIG. 5/STEP 416 . . . YES), the type identifier, the posture identifier and the acting force factor are transmitted to the server configuring the crane deformation state estimation system 20 by a terminal wireless communication device configuring the terminal output interface 42, by the terminal controller 44 (FIG. 5/STEP 418).

In the crane deformation state estimation system 20, the type identifier, the posture factor and the acting force factor are received by the input processing element 21 (FIG. 5/STEP 210). By the estimation processing element 24, a crane model corresponding to the type identified by the type identifier is read or retrieved from the crane model database 28 (FIG. 5/STEP 212). By the estimation processing element 24, the deformation state in the virtual space of the attachment 14 of the crane 10 is estimated according to the crane model based on the posture factor and the acting force factor (FIG. 5/STEP 214). Thus, the elevation angle deviation Δθ₁=θ₁(m)−θ₁(0) relative to the horizontal plane of the boom 141, as the deformation state or the deflection amount of the boom 141 when the suspended load of the mass m is lifted by the attachment 14 in the condition where the boom 141 is in the posture of forming the elevation angle θ₁(m) relative to the horizontal plane and the jib 142 is in the posture of forming the elevation angle θ₂(m) relative to the horizontal plane, and the elevation angle deviation Δθ₂=θ₂(m)−θ₂(0) relative to the horizontal plane of the jib 142 are estimated as the deformation states or the deflection amounts of the boom 141 and the jib 142 (see FIG. 4).

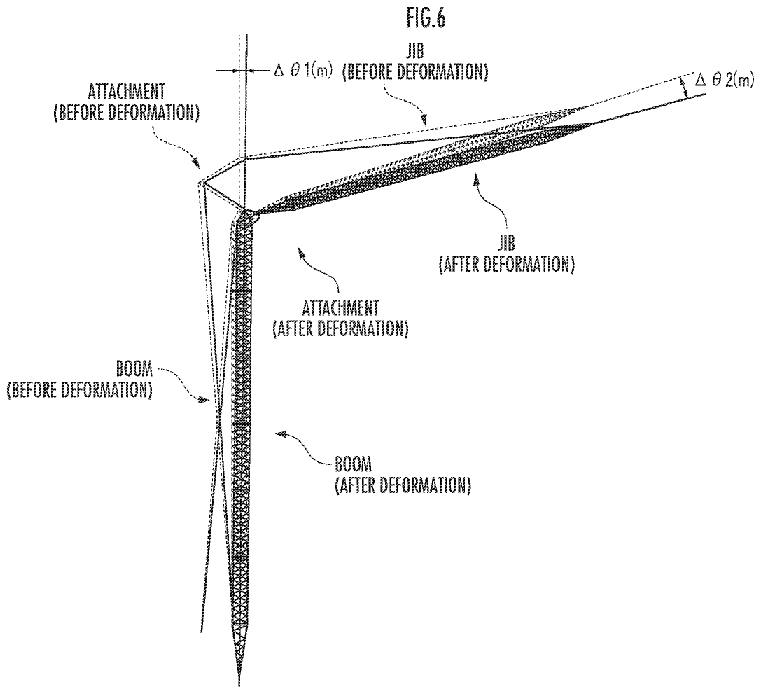

Subsequently, the estimation result is transmitted to the terminal device 40 by the output processing element 22 (FIG. 5/STEP 220). Accordingly, the estimation result is received through the terminal wireless communication device by the terminal controller 44 in the terminal device 40 (FIG. 5/STEP 420). Then, by the terminal controller 44, a screen indicating the estimation result is outputted to the terminal output interface 42 (FIG. 5/STEP 420). Thus, as illustrated in FIG. 6 for example, the attachment 14 before deformation in the posture specified by the posture factor and the attachment 14 after the deformation according to the force virtually acting in the state specified by the acting force factor are simulatively expressed, and a screen indicating numerical values of the elevation angle deviations 401 and 402 indicating the deformation amount is outputted to the terminal output interface 42.

(Effects)

According to the crane deformation state estimation system 20 which demonstrates the functions described above, the respective deformation states of the boom 141 (first attachment element) and the jib 142 (second attachment element) configuring the attachment 14 connected to the crane main body so as to perform the derricking motion are estimated according to the crane model. The crane model is the model indicating the correlation among the “acting force factor” for specifying the acting state of the force on the attachment 14 connected to the crane main body so as to perform the derricking motion, the “posture factor” for specifying the posture of each of the boom 141 and the jib 142 and “angle changes (elevation angle deviations Δθ₁ and Δθ₂)” indicating the respective deformation states of the boom 141 and the jib 142 (see FIG. 4). That is, in the crane model, the respective deformation states of the boom 141 and the jib 142 configuring the attachment 14 in a certain posture according to the acting state of the force on the attachment 14 are expressed by respective angle change amounts of the boom 141 and the jib 142. Therefore, accuracy for estimation of the deformation states of the boom 141 and the jib 142 is improved even while reducing a data amount by expressing the deformation state specified by the deflection amount or the like of each attachment element by a single angle representing the plurality of points, compared to the case of expressing it by respective displacement states of a plurality of parts of each attachment element or respective displacement vectors of the plurality of points.

### Other Embodiments of Present Invention

While the crane deformation state estimation system 20 is configured by the server having an intercommunicating function with the terminal device 40 in the embodiment described above, the crane deformation state estimation system 20 may be configured by the terminal device 40 as another embodiment.

While the respective deformation states of the boom 141 and the jib 142 are expressed or estimated as the respective elevation angle deviations Δθ₁ and Δθ₂ of the boom 141 and the jib 142 on the plane parallel to the x-z plane of the actual machine coordinate system in the embodiment described above, as another embodiment, the respective deformation states of the boom 141 and the jib 142 may be expressed or estimated as the respective elevation angle deviations Δθ₁ and Δθ₂ of the boom 141 and the jib 142 on the plane parallel to a y-z plane or an x-y plane of the actual machine coordinate system. The deformation state of the attachment 14 may be expressed or defined by a twist direction and a twist amount of the attachment 14 in addition to a deflection direction and the deflection amount of the attachment 14.

While the state where the force derived from the mass m of the suspended load lifted by the attachment 14 and also the gravity of the suspended load acts on the attachment 14 via the wire is defined or specified by a acting force factor in the embodiment described above, as another embodiment, instead of or in addition to the mass m of the suspended load, by a time change state of a turning angle velocity and/or a turning angle acceleration of the upper turning body 12 relative to the lower traveling body 11, a time change state of a derricking angle velocity and/or a derricking angle acceleration of the boom 141 and a time change state of a derricking angle velocity and/or a derricking angle acceleration of the jib 142, the acting state of inertial force which is originated from the angle velocity and/or the angle acceleration and acts on the attachment 14 may be defined or specified by the acting force factor.

### REFERENCE SIGNS LIST

10 . . . crane, 11 . . . lower traveling body, 12 . . . upper turning body, 14 . . . attachment, deformation state estimation system, 21 . . . input processing element, 22 . . . output processing element, 24 . . . estimation processing element, 28 . . . crane model database, device, 41 . . . terminal input interface, 42 . . . terminal output interface, 44 . . . terminal controller, 100 . . . actual machine controller, 101 . . . sensor group, 102 . . . actual machine operation mechanism, 104 . . . drive mechanism, 124 . . . cab (driver's cab), 141 . . . boom, 142 . . . jib, 1021 . . . actual machine input interface, 1022 . . . actual machine output interface.

1. A crane deformation state estimation system,
the system comprising an arithmetic processing unit for estimating a virtual deformation state of an attachment which is connected to a crane main body so as to perform a derricking motion in a crane and is deformed according to each of external force and inertial force,
wherein the arithmetic processing unit comprises:
an input processing element configured to recognize an acting force factor for specifying an acting state of force on the attachment and a posture factor for specifying a posture of the attachment, which are inputted through an input interface;
an estimation processing element configured to estimate, as a deformation state of the attachment, an angle change state indicating the deformation state of the attachment in a condition where the force is acting on the attachment in the state specified by the acting force factor with the posture specified by the posture factor for the attachment as a reference, according to a crane model indicating a correlation among the acting force factor, the posture factor and the angle change state indicating the deformation state of the attachment, based on the acting force factor and the posture factor recognized by the input processing element; and
an output processing element configured to make an output interface output information indicating the deformation state of the attachment estimated by the estimation processing element.

2. The crane deformation state estimation system according to claim 1,
wherein the input processing element recognizes, as the posture factor, each of a first posture factor for specifying the posture of a first attachment element which configures the attachment and is connected to the crane main body so as to perform the derricking motion and a second posture factor for specifying the posture of a second attachment element directly or indirectly connected to the first attachment element so as to change at least one of the posture and a position, and
the estimation processing element estimates, as the deformation state of the attachment, the angle change state indicating the posture change state of each of the first attachment element and the second attachment element in the condition where the force is acting on the attachment in the state specified by the acting force factor with the posture specified by the posture factor for the attachment as the reference.

3. The crane deformation state estimation system according to claim 1,
wherein the input processing element recognizes weight of a suspended load lifted by the attachment as the acting force factor.
